(19) United States
(12) Patent Application Publication
(10) Pub. No.: US 2021/0267413 A1
(43) Pub. Date: Sep. 2, 2021

(54) MULTI-MODE COOKER WITH ADVANCED CONTROLS

(71) Applicant: W.C. BRADLEY CO., Columbus, GA (US)

(72) Inventors: BRUCE ROBERTS, Phenix City, AL (US); RAMIN KHOSRAVI RAHMANI, Columbus, GA (US); ANTHONY HAMILTON, Hamilton, GA (US); SLEIMAN ABDALLAH, Columbus, GA (US)

(21) Appl. No.: 17/188,874

(22) Filed: Mar. 1, 2021

Related U.S. Application Data
(60) Provisional application No. 62/983,313, filed on Feb. 28, 2020.

(51) Int. Cl. A47J 37/07; F24B 13/04

(52) U.S. Cl. CPC A47J 37/0786; F24B 13/04; A47J 37/0704

(57) ABSTRACT

A cooking device includes a cooking chamber containing a fire pot that receives pellet fuel for combustion under positive pressure from an air supply and an offset combustion chamber adjacent to the cooking chamber. The device includes a smoke valve that is selectively openable to allow gas flow from the offset combustion chamber to the cooking chamber, and a pressure conduit containing a pressure valve that, when open, provides positive pressure from the air supply to the offset combustion chamber and, when closed, inhibits positive pressure from the air supply to the offset combustion chamber.

### CROSS-REFERENCE TO RELATED CASES

This application claims the benefit of U.S. provisional patent application Ser. No. 62/983,313, filed on Feb. 28, 2020, and incorporates such provisional application by reference into this disclosure as if fully set out at this point.

### FIELD OF THE INVENTION

This disclosure relates to cooking appliances in general and, more specifically, to outdoor cooking appliances with multiple modes of operation.

### BACKGROUND OF THE INVENTION

Various outdoor cooking appliances and devices may rely on pelletized fuel for cooking or smoking operations. Pellet fueled grills normally utilized positive pressure air flow into a fire pot to supply combustion air for the burning fuel. This positive pressure into the internal fire pot also increases the air pressure inside the entire cooking chamber. This has made pellet grills unsuitable for use with an integrated offset smoker that normally relies on convection air flow to supply combustion air and for movement of heated gases and smoke.

What is needed is a system and method for addressing the above and related issues.

### SUMMARY OF THE INVENTION

The invention of the present disclosure, in one aspect thereof, comprises a cooking device including a cooking chamber containing a fire pot that receives pellet fuel for combustion under positive pressure from an air supply and an offset combustion chamber adjacent to the cooking chamber. The device includes a smoke valve that is selectively openable to allow gas flow from the offset combustion chamber to the cooking chamber, and a pressure conduit containing a pressure valve that, when open, provides positive pressure from the air supply to the offset combustion chamber and, when closed, inhibits positive pressure from the air supply to the offset combustion chamber.

The cooking device may further comprise a smoke valve control that is exterior to the cooking chamber and the offset combustion chamber and operatively connected to the smoke valve to open and close the smoke valve. The device may comprise a pressure control that is exterior to the cooking chamber and the offset combustion chamber and operatively connected to the pressure valve to open and close the pressure valve. The pressure control may be operative to place and retain the pressure valve in at least one partially open position.

In some embodiments, the device has a cooking grate inside the cooking chamber superior to the fire pot, and a heat spreader interposing the cooking grate and the fire pot and dispersing a flow of gases from the firepot toward the cooking grate. The heat spreader may define an opening above the fire pot and provide a sear control that selectively covers and uncovers the opening above the fire pot.

The offset combustion chamber may define a manifold directing air from the pressure conduit to a plurality of air ducts therein. The plurality of air ducts may further comprise a plurality of louvres directing airflow from the airducts in a predetermined direction inside the offset combustion chamber.

In some embodiments, the offset combustion chamber contains a smoking rack situated above a fuel rack. The offset combustion chamber may provide an adjustable air intake between a level of the smoking rack and a level of the fuel rack. The pressure conduit may communicate with the offset combustion chamber below the level of the smoking rack and the smoke valve may be situated above the level of the smoking rack.

The invention of the present disclosure, in another aspect thereof, comprises a cooking device having a cooking chamber supporting a cooking grate. A solid fuel firepot is below the cooking grate and a fuel feed mechanism supplies fuel to the firepot. An air plenum delivers pressurized air to the firepot and an offset combustion chamber selectively communicate with the cooking chamber to supply smoke. A pressure conduit adjustably supplies pressurized air into the combustion chamber.

In some embodiments, the cooking device further comprises a pressure valve having a plurality of selectable positions including open, closed, and at least one partially open position. The device may have a smoke valve having at least an open and closed position for placing the offset combustion chamber in communication with the cooking chamber.

The offset combustion chamber may include a manifold routing pressurized air from the pressure conduit to a plurality of air ducts distributing the pressurized air within the offset combustion chamber. The device may include an adjustable air inlet to the offset combustion chamber.

Some embodiments include a heat spreader interposing the fire pot and the cooking chamber, the heat spreader providing a sear control plate that is adjustable to alter gas flow through the heat spreader to concentrate or spread combustion gases relative to a location on the cooking grate.

The invention of the present disclosure, in another aspect thereof, comprises a method of cooking including providing a cooking chamber containing a fire pot that receives pellet fuel for combustion under positive pressure from an air supply, an offset combustion chamber adjacent to the cooking chamber, a smoke valve that is selectively openable to allow gas flow from the offset combustion chamber to the cooking chamber, and a pressure conduit containing a pressure valve that, when open, provides positive pressure from the air supply to the offset combustion chamber and, when closed, inhibits positive pressure from the air supply to the offset combustion chamber.

In some embodiments, the method includes creating a solid fuel heat source in the fire pot, initiating a smoke generating heat source in the offset combustion chamber, opening the smoke valve, and opening the pressure conduit. In other embodiments the method may include creating a smoke generating heat source in the offset combustion chamber, closing the pressure conduit, and opening the smoke valve.

### BRIEF DESCRIPTION OF THE DRAWINGS

FIG. 1 is a perspective view of a multi-mode cooker with advanced controls according to aspects of the present disclosure.

FIG. 2 is a perspective cutaway view of the multi-mode cooker with advanced controls according to aspects of the present disclosure.

FIG. 3 is a side cutaway view of the multi-mode cooker with advanced controls according to aspects of the present disclosure.

FIG. 4 is a side cutaway closeup view of the multi-mode cooker with advanced controls according to aspects of the present disclosure with some components removed for illustrative purposes.

FIG. 5 is a perspective cutaway closeup view of the multi-mode cooker with advanced controls according to aspects of the present disclosure.

FIG. 6 is a left end closeup cutaway view of the multi-mode cooker with advanced controls according to aspects of the present disclosure.

FIG. 7 is another left end closeup cutaway view of the multi-mode cooker with advanced controls according to aspects of the present disclosure.

FIG. 8 is another left end closeup cutaway view of the multi-mode cooker with advanced controls according to aspects of the present disclosure.

FIG. 9 is a left end closeup cutaway view of the multi-mode cooker with advanced controls according to aspects of the present disclosure with some components removed for illustrative purposes.

FIG. 10 is a right end closeup cutaway view of the multi-mode cooker with advanced controls according to aspects of the present disclosure.

FIG. 11 is another right end closeup cutaway view of the multi-mode cooker with advanced controls according to aspects of the present disclosure.

FIG. 12 is a perspective cutaway closeup view of the multi-mode cooker with advanced controls according to aspects of the present disclosure with some components removed for illustrative purposes.

FIG. 13 is a perspective closeup view of a multi-mode perspective cooker according to aspects of the present disclosure.

### DETAILED DESCRIPTION OF THE PREFERRED EMBODIMENTS

Disclosed herein are various embodiments of a multi-mode cooker with advanced controls. The advanced controls may include various valves and flaps that may be adjustable to on or off, open or closed, or partially on/off or open/closed. Controls may also include air intake and outlet controls as well as fuel feed and pressurized combustion air controls.

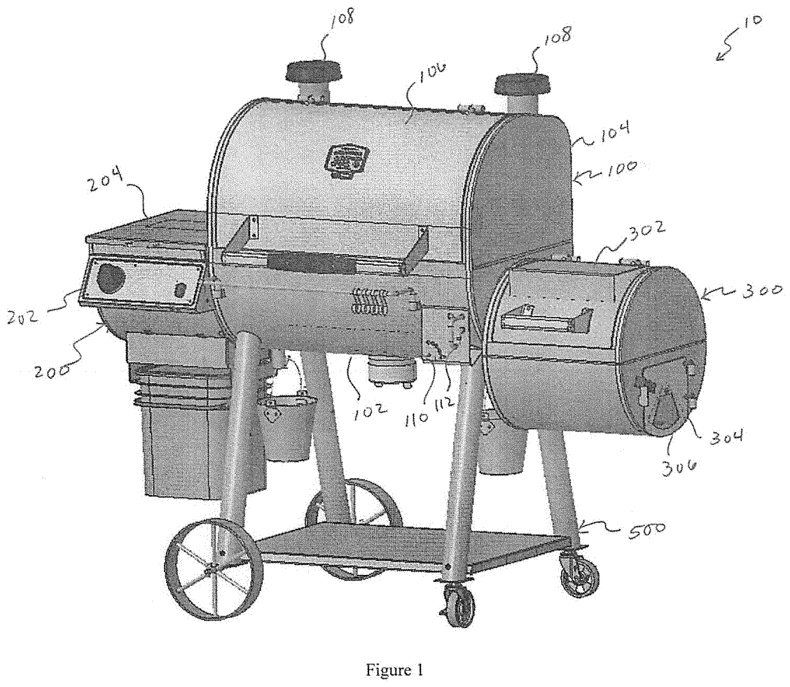

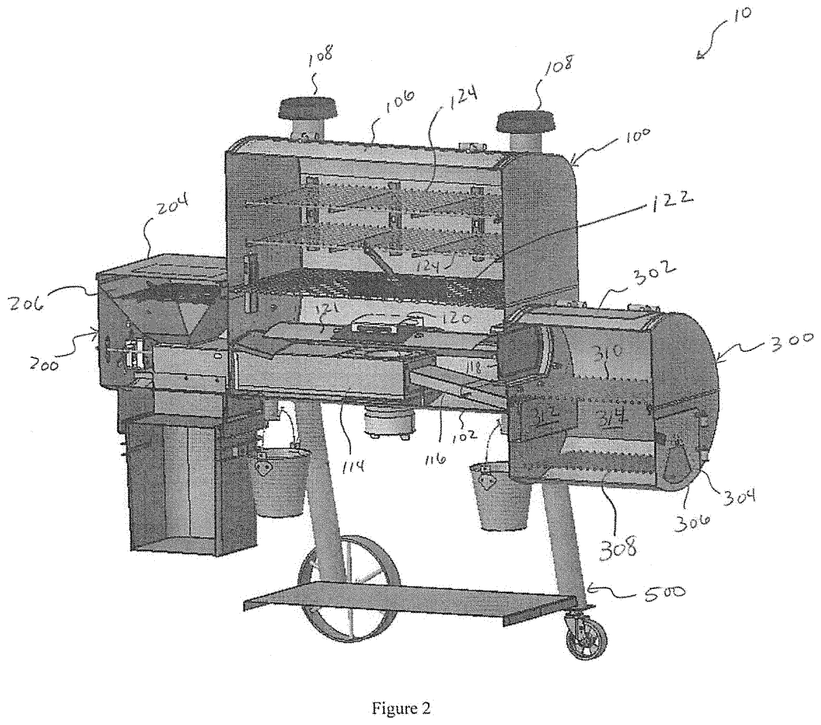

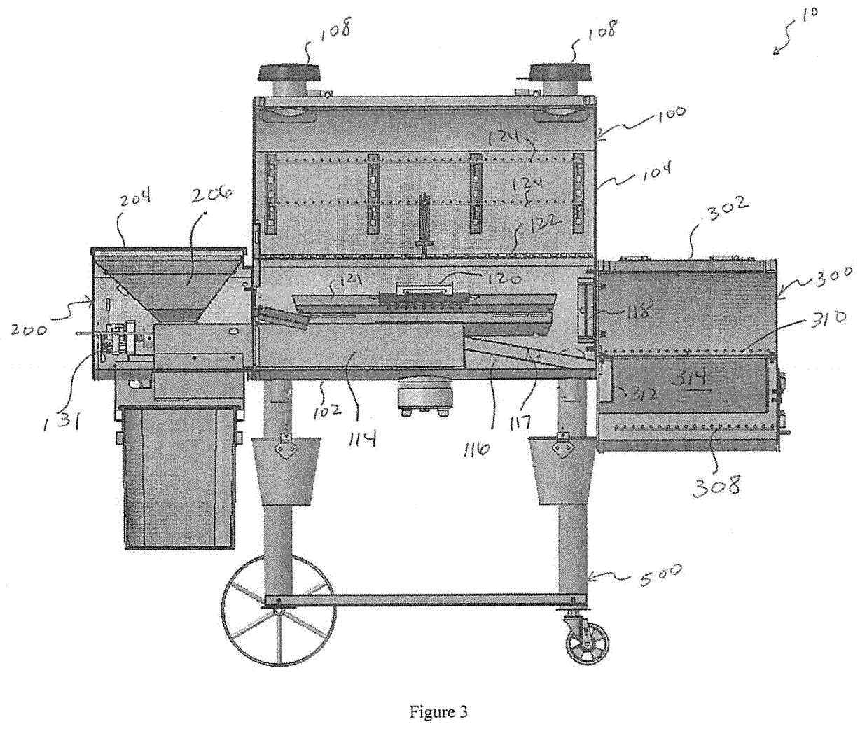

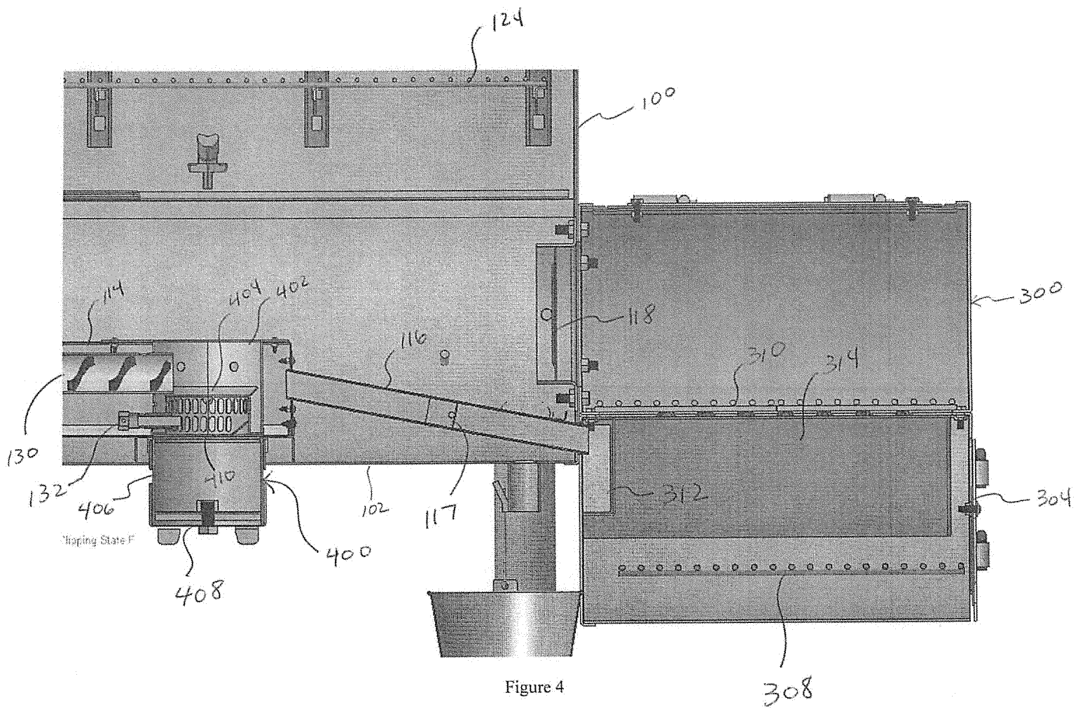

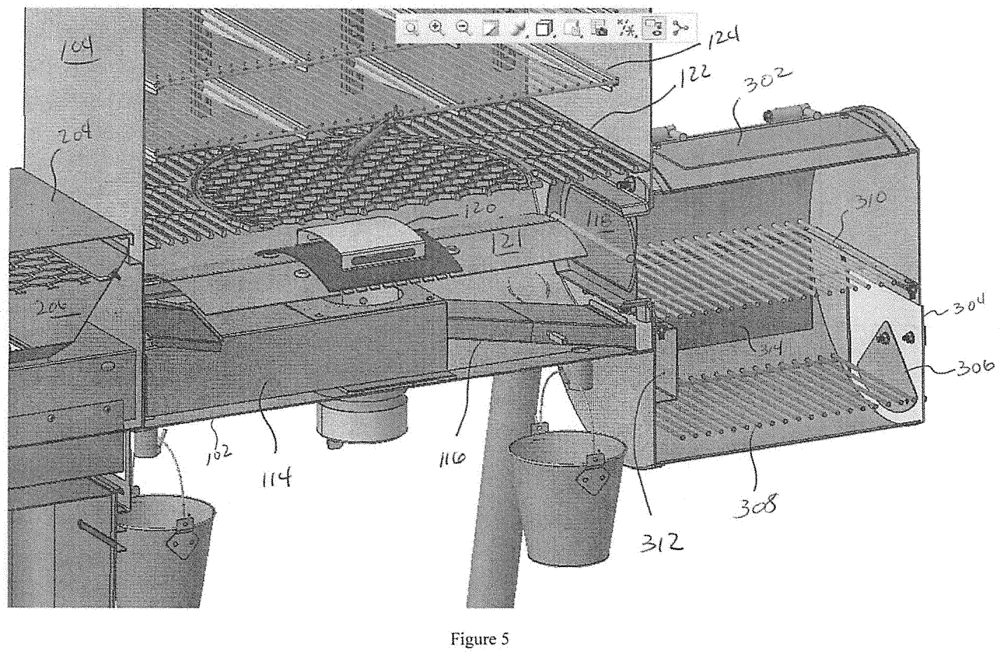

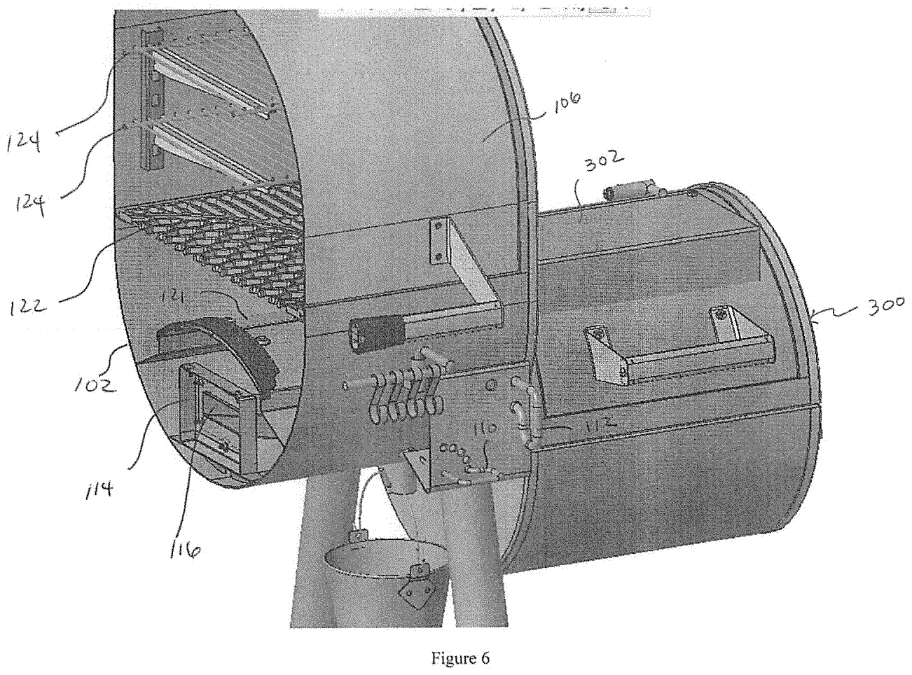

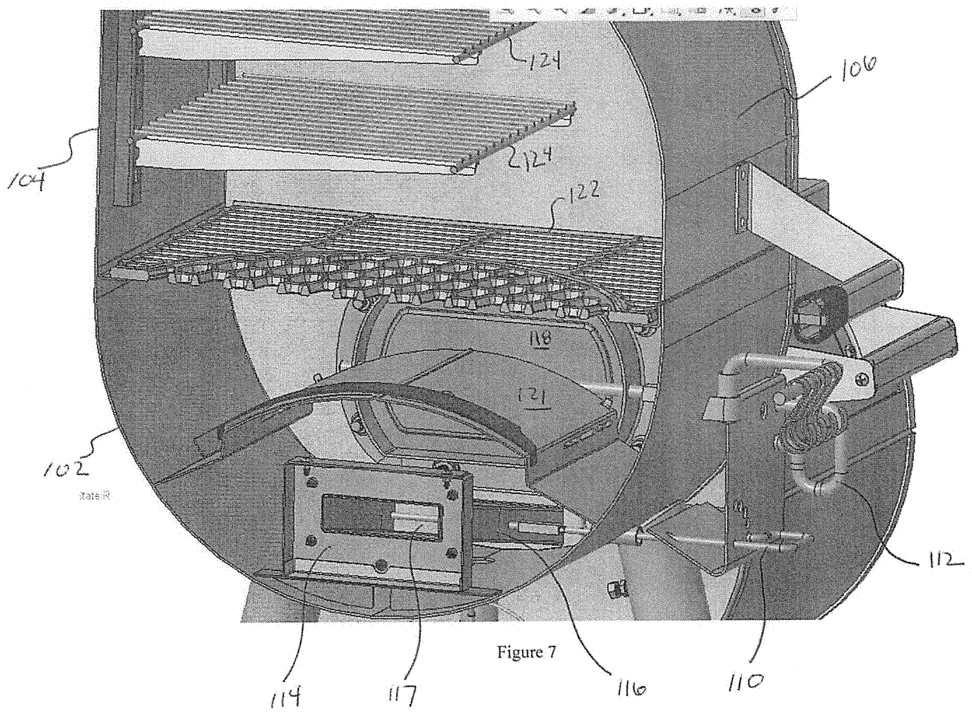

FIG. 1 is a perspective view of a multi-mode cooker with advanced controls 10 according to aspects of the present disclosure. FIG. 2 is a perspective cutaway view and FIG. 3 is a side cutaway view, both of the multi-mode cooker 10 with advanced controls according to aspects of the present disclosure. FIG. 4 is a side cutaway closeup view of the multi-mode cooker with advanced controls 10 according to aspects of the present disclosure with some components removed for illustrative purposes. FIG. 5 is a perspective cutaway closeup view; FIG. 6 is a left end closeup cutaway view of the multi-mode cooker with advanced controls according to aspects of the present disclosure; and FIG. 7 is another left end closeup cutaway view of the multi-mode cooker with advanced controls 10 according to aspects of the present disclosure.

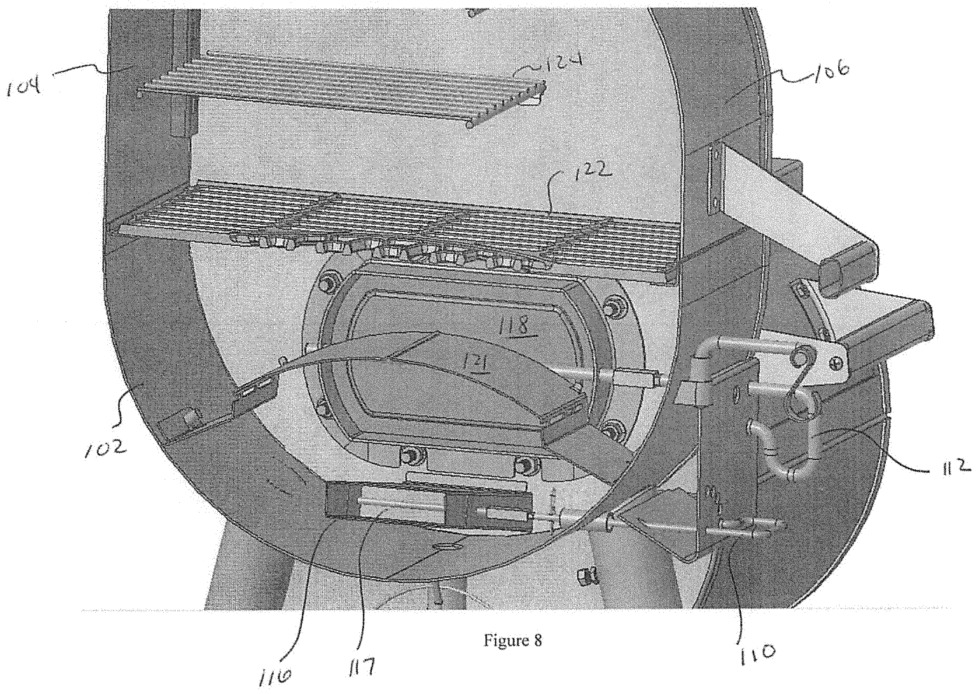

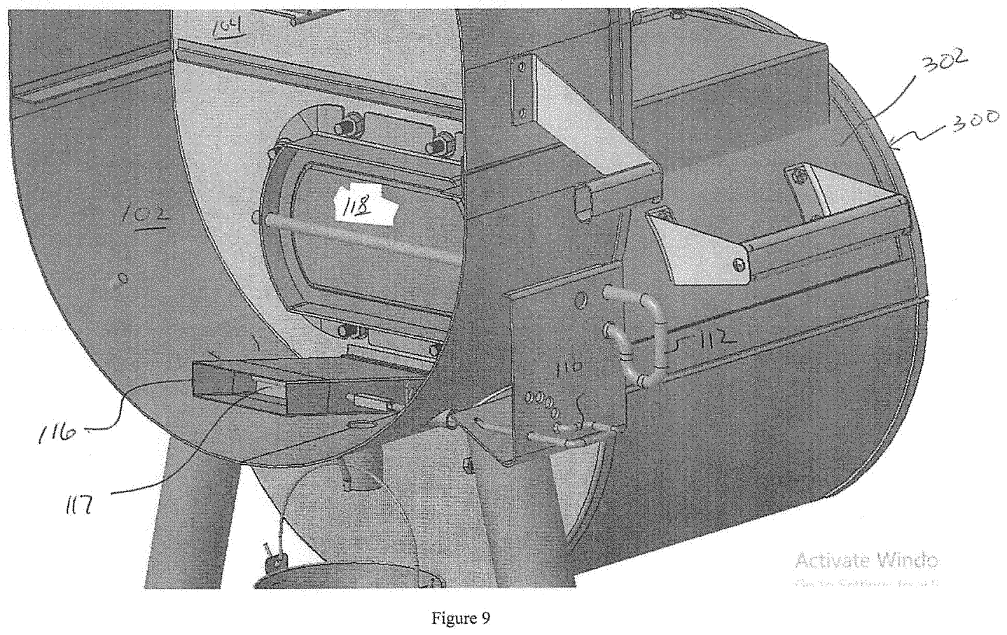

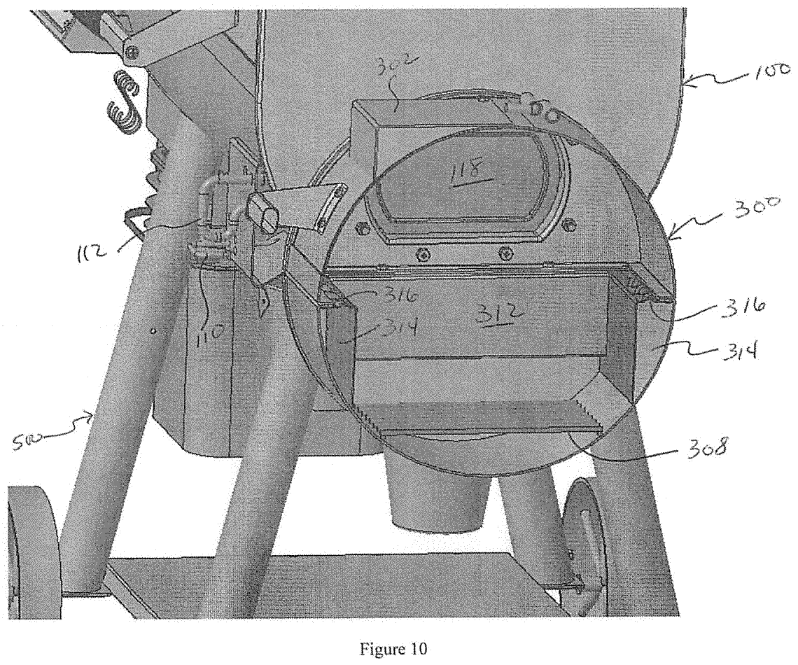

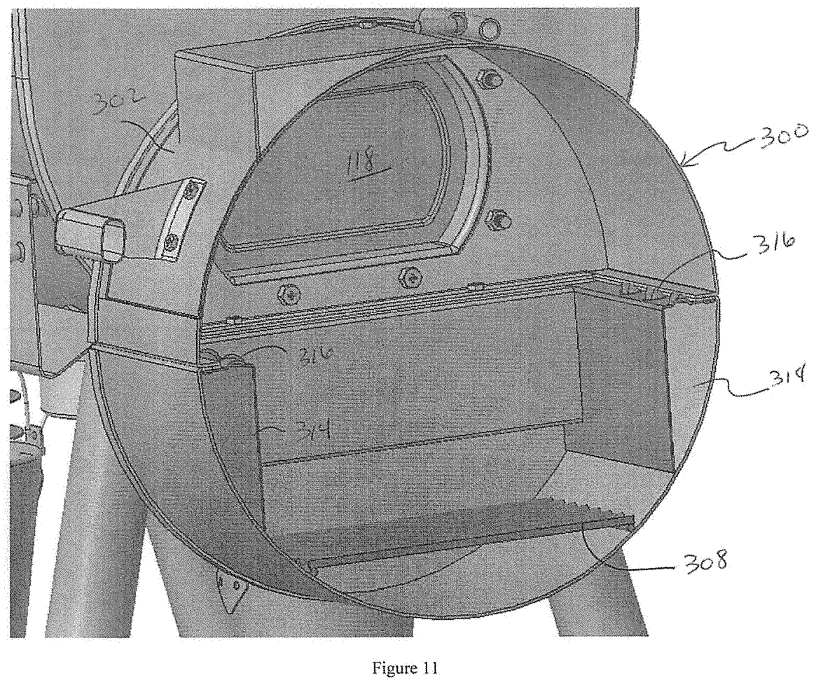

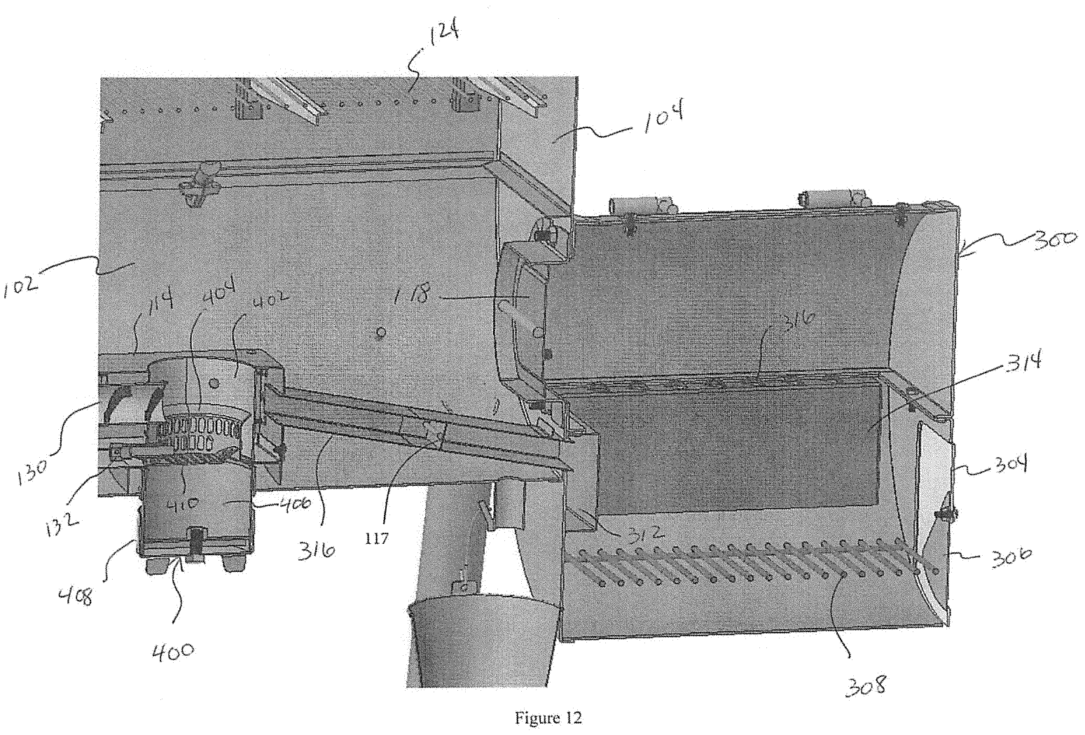

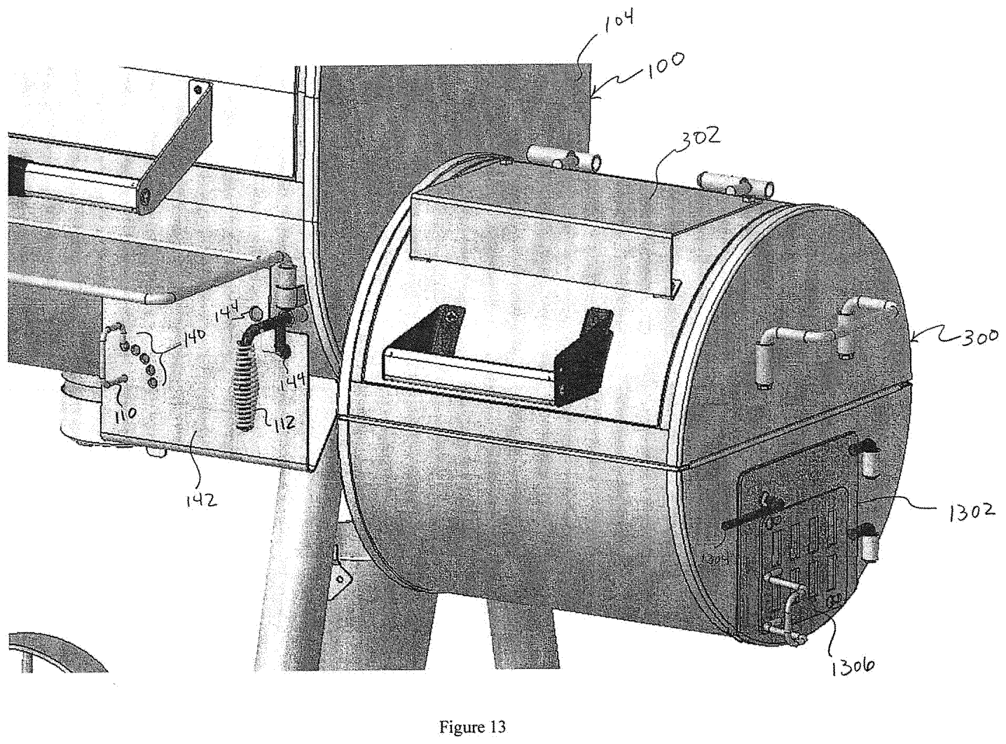

FIG. 8 is another left end closeup cutaway view of the multi-mode cooker with advanced controls 10 according to aspects of the present disclosure. FIG. 9 is a left end closeup cutaway view of the multi-mode cooker with advanced controls 10 according to aspects of the present disclosure with some components removed for illustrative purposes. FIG. 10 is a right end closeup cutaway view of the multi-mode cooker with advanced controls 10 according to aspects of the present disclosure. FIG. 11 is another right end closeup cutaway view of the multi-mode cooker with advanced controls 10 according to aspects of the present disclosure. FIG. 12 is a perspective cutaway closeup view of the multi-mode cooker with advanced controls 10 according to aspects of the present disclosure with some components removed for illustrative purposes. FIG. 13 provides an additional closeup perspective view.

Like components have like numerals. However, it should be understood that not every embodiment provides for every illustrated component. One of ordinary skill in the art will appreciate, from the present disclosure, suitable materials, methods of manufacture, and parts not made explicitly mentioned that are needed to make and use devices, systems, and methods based on the present disclosure.

The cooker 10 may comprise generally a cooking chamber 100 having a lower firebox 102 and an upper chamber 104. The firebox 102 contains a heat source such as a firepot 400 and may also be provided cooking smoke from an offset combustion chamber 300 via a smoke valve 118. The upper chamber 104 may comprise a cooking grate 122 as well as various warming racks 124 or secondary cooking grates. The cooking grate 122 and/or warming racks may comprise unitary components or multi-piece components including complementary pieces and/or inserts. The upper chamber 104 may be fitted with a lid 106 for accessing the internal components and food being cooked. Exhaust gases and smoke from the cooking processes may escape via one or more smokestacks 108, which may or may not be adjustable.

Illustrated on the left side of the cooker 10, though it could easily be adapted for mounting elsewhere, is a pellet feeding mechanism 200. Solid pelletized fuel may be handled via the pellet feeding mechanism, but other types of solid fuel could also be used (e.g., chips, chunks, etc.). A hopper 206 is provided that selectively feeds fuel to a fuel feed mechanism 130. The fuel feed mechanism 130 is shown as an auger. However, the fuel feed mechanism 130 may also comprise a push feed system, a conveyor, a slick stick mechanism, or other type of controllable fuel delivery system. A lid 204 may be provided allowing a user access to the hopper 206 for fueling operations and the like. In some embodiments, the fuel feed mechanism 130 is powered by an electric motor 131.

The fuel feed mechanism 130 selectively introduces pelletized or other solid fuel into the firepot 400. The firepot 400 may comprise an outer chamber 402 defined by an outer chamber wall and surrounding an inner chamber 404 defined by an inner chamber wall (see FIG. 4). The outer chamber 402 and inner chamber 404 may comprise perforated walls to allow introduction of combustion air. Fuel is fed from the fuel feed mechanism into the inner chamber 404 of the firepot 400. The inner chamber 402 may be funneled (i.e., the wall may define a funnel at or near a top thereof) to promote capture of fuel dropped into it.

An electric ignitor 132 may selectively heat and/or ignite fuel within the inner chamber 404. At least the inner chamber 404 may have a perforated floor 410, portions of which may be slopped or slanted to promote even distribution and burning of fuel from the fuel feed mechanism 130. The outer chamber 404 may share a perforated floor or may provide a separate perforated floor surrounding the inner chamber 402. An ash chamber 406 may be situated below the inner and/or outer chamber 402, 404. A removable cap or pan 408 may be provided for ash removal.

The firepot 400, or at least the outer chamber 402, may be at least partially contained inside an air plenum 114. The air plenum 114 provides a supply of pressurized air (possibly coming from the pellet feeding mechanism via an electric fan). The pressurized air from the plenum penetrates through to the outer chamber 402 and supplies the combustion of the inner chamber with combustion air which enters through the perforated wall of the inner chamber 404. The wall of the outer chamber 404 is prevented from being blocked by fuel or other debris (since fuel burns inside the inner chamber 402) and thus combustion is more uniform.

The firepot 400 may have an open top configuration such that the majority of the heat produced by gas flow exits the top. This may lead to a concentration of heat directly over the firepot 400. Some embodiments provide for a heat spreader 121 which may serve to spread combustion gas more thoroughly throughout the cooking chamber 100. The head spreader 121 may also reduce some cooking effects from convection while increasing some cooking effects due to infrared or re-radiation. A sear control 120 may allow the user to adjust heat concentration on certain area of the cooking grate 122.

In some embodiments, the het spreader 121 comprises a gas-impermeable plate or barrier that forces heat and combustion gases to distribute away from the fire pot 400 before rising. The heat spreader 121 may be detached or spaced apart from walls of the firebox 102 to allow for gas flow around front, back, and/or sides of the heat spreader 121. Various openings may be defined through the heat spreader to allow gas flow where needed. In some embodiments, one or more gas flow openings are provided that are selectively covered by the sear control 120. The sear control may comprise a gas-impermeable structure and/or a gas restricting structure that can be used to increase or decrease concentrated heat near a center of the cooking grate 122 (or wherever under the cooking grate 122 the fire pot 400 lies).

A pressure conduit 116 may lead from the plenum 114 (or another source of pressurized air) to the offset combustion chamber 300. The offset combustion chamber is shown on the right but could be configured to be placed otherwise. Air from the conduit 116 may be routed to a manifold 312 in the combustion chamber 300, which routes the air to ducts 314. Ducts 314 may run down all or a portion of the length (here, left to right) of the combustion chamber 300.

In some embodiments, the combustion chamber 300 supplies smoke for cooking. The smoke may be used within the combustion chamber itself using a smoking rack 310, for example. The combustion chamber 300 may provide a lid 302 for accessible the smoking rack 310, food, or other items. A fuel rack 308 may also be provided. A fuel door 304 may be provided, along with an adjustable and/or closeable air intake 306.

In operations where smoking is to be accomplished in the cooking chamber 100, smoke valve 118 may be opened to allow smoke to escape from the combustion chamber 300 into the cooking chamber. However, if the firepot 400 is being used under positive pressure, pressure within the cooking chamber may be higher than within the combustion chamber 300, which inhibits smoke flow. Thus, by opening a pressure valve 117 in the pressure conduit 116 high pressure air is provided to the ducts 314. Vent ports 316 (FIG. 12) allow the pressurized air to enter the combustion chamber 300 increasing the pressure in the combustion chamber by an amount great enough to provide smoke flow out of the combustion chamber 300 into the cooking chamber 100. The vent ports 316 may be louvred or provided with vanes or other direction modifying means. In some embodiments, the vent ports 316 open to an area above the fuel grate 308, and possibly near to or above the smoking grate 310. In this way, smoke produced below and reaching near to the smoke valve 118 area can escape, but fuel burning on the fuel rack 308 is not burned in an excessively hot manner due to the introduction and flow of the pressurized air.

Accessible outside the cooker 10 may be pellet and air controls 202. These may control, for example, delivery of fuel into the firepot 400 and well as pressurization and air flow into the plenum 114.

A pressure control 110 may open and close the pressure valve 117 to pressurize the combustion chamber 300. The control 110 may allow the pressure valve 117 to be completely opened or closed, or held in a partially open position. The control 110 may have a sliding engagement with the pressure valve 117 such that retention holes 140 in control plate 142 (as shown in FIG. 13) may selectively retain the control 110 in one of a finite number of positions. A sliding engagement is taken to mean that the control can rotate (open or close) the valve but is also free to translate laterally with respect to the valve. One of skill in the art will appreciate that detent mechanisms or other devices may be used to achieve the same or similar effect.

A smoke valve control 112 allows the smoke valve 118 to be opened or closed. Fine tuning of the smoke flow may occur via the pressure control 110. The smoke valve control 112 have a sliding engagement with the smoke valve 118 such that it may be retained by retention holes 144 in control plate 142 in either open or closed position. In other embodiments, the position of the smoke valve 118 may be such that the valve 118 may be held in a partially open position. Some degree of control may also be provided by adjustment of the vent 304 on the combustion chamber.

The control mechanisms of the present disclosure allow the cooker 10 to be utilized as a smoker-only by producing smoke in the combustion chamber 300 for use in the combustion chamber 300, for use in the cooking chamber 100, or both. Pressurized air may not be used in such a configuration and smoke can be trapped in the combustion chamber or allowed to move into the cooking chamber 100 by adjustment of the smoke valve 118. The cooker 10 may be used as a pellet grill-only by operating the firepot. In such configuration the pressure valve 117 and smoke valve 118 may both be closed. Where cooking operations utilizing the firepot 400 are desired with an increased level of smoke, the firepot 400 may be operated with the pressure valve 117 and smoke valve 118 both at least partially open, and a smoke producing fuel being combusted in the combustion chamber 300. As this is occurring, a user may also cook concurrently with a lower temperature smoking configuration in the combustion chamber.

As also shown in FIG. 13, the door 304 may be replaced with a door 1302. The door 1302 provides similar functionality but utilizes a slidable air intake cover 1306 to control air flow through slots in the door 1302 and into the combustion chamber 300. A handle 1304 having an internal latch mechanism may selectively secure the door.

The illustrated embodiments of the present disclosure provide for manual selective operation of the pressure valve 117, the smoke valve 118, the intake 306, and intake cover 1306, and possibly the smokestacks 108. However, these may also be operated with electromechanical actuators instead or, or in addition to, the option for manual operation. Such electromechanical actuators may be operated with separate or discrete controls (such as knobs, sliders, buttons, and the like) or may be controlled by an algorithm executed by a circuit and/or processor. The operations may be simple (such as a smoking, grilling, or combo operation) or may be more finely controlled (such as having various amounts of pressure into the combustion chamber 300). Such automated controls may be integral with or separate from the controls 202 provided for the pellet feeding operation.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The term “at least” followed by a number is used herein to denote the start of a range beginning with that number (which may be a ranger having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%.

When, in this document, a range is given as “(a first number) to (a second number)” or “(a first number)-(a second number)”, this means a range whose lower limit is the first number and whose upper limit is the second number. For example, 25 to 100 should be interpreted to mean a range whose lower limit is 25 and whose upper limit is 100. Additionally, it should be noted that where a range is given, every possible subrange or interval within that range is also specifically intended unless the context indicates to the contrary. For example, if the specification indicates a range of 25 to 100 such range is also intended to include subranges such as 26-100, 27-100, etc., 25-99, 25-98, etc., as well as any other possible combination of lower and upper values within the stated range, e.g., 33-47, 60-97, 41-45, 28-96, etc. Note that integer range values have been used in this paragraph for purposes of illustration only and decimal and fractional values (e.g., 46.7-91.3) should also be understood to be intended as possible subrange endpoints unless specifically excluded.

It should be noted that where reference is made herein to a method comprising two or more defined steps, the defined steps can be carried out in any order or simultaneously (except where context excludes that possibility), and the method can also include one or more other steps which are carried out before any of the defined steps, between two of the defined steps, or after all of the defined steps (except where context excludes that possibility).

Further, it should be noted that terms of approximation (e.g., “about”, “substantially”, “approximately”, etc.) are to be interpreted according to their ordinary and customary meanings as used in the associated art unless indicated otherwise herein. Absent a specific definition within this disclosure, and absent ordinary and customary usage in the associated art, such terms should be interpreted to be plus or minus 10% of the base value.

The term “selective” or “selectively,” unless otherwise indicated, is taken to mean that the operation or function is capable of being performed by the structure or device in reference, but the operation or function may not occur continuously or without interruption. Furthermore, a selective or selectively performed operation may be one that the user or operator of a device or method may choose whether or when to perform, but the function or operation is nevertheless fully operative on or within the relevant device, machine, or method and the same includes the necessary structure or components to perform such operation.

Thus, the present invention is well adapted to carry out the objects and attain the ends and advantages mentioned above as well as those inherent therein. While the inventive device has been described and illustrated herein by reference to certain preferred embodiments in relation to the drawings attached thereto, various changes and further modifications, apart from those shown or suggested herein, may be made therein by those of ordinary skill in the art, without departing from the spirit of the inventive concept the scope of which is to be determined by the following claims.

What is claimed is:

1. A cooking device comprising:
a cooking chamber containing a fire pot that receives pellet fuel for combustion under positive pressure from an air supply;
an offset combustion chamber adjacent to the cooking chamber;
a smoke valve that is selectively openable to allow gas flow from the offset combustion chamber to the cooking chamber; and
a pressure conduit containing a pressure valve that, when open, provides positive pressure from the air supply to the offset combustion chamber and, when closed, inhibits positive pressure from the air supply to the offset combustion chamber.

2. The cooking device of claim 1, further comprising a smoke valve control that is exterior to the cooking chamber and the offset combustion chamber and operatively connected to the smoke valve to open and close the smoke valve.

3. The cooking device of claim 1, further comprising a pressure control that is exterior to the cooking chamber and the offset combustion chamber and operatively connected to the pressure valve to open and close the pressure valve.

4. The cooking device of claim 3, wherein the pressure control is operative to place and retain the pressure valve in at least one partially open position.

5. The cooking device of claim 1, further comprising:
a cooking grate inside the cooking chamber superior to the fire pot; and
a heat spreader interposing the cooking grate and the fire pot and dispersing a flow of gases from the firepot toward the cooking grate.

6. The cooking device of claim 5, wherein the heat spreader defines an opening above the fire pot and provides a sear control that selectively covers and uncovers the opening above the fire pot.

7. The cooking device of claim 1, wherein the offset combustion chamber defines a manifold directing air from the pressure conduit to a plurality of air ducts therein.

8. The cooking device of claim 7, wherein the plurality of air ducts comprise a plurality of louvres directing airflow from the airducts in a predetermined direction inside the offset combustion chamber.

9. The cooking device of claim 8, wherein the offset combustion chamber contains a smoking rack situated above a fuel rack.

10. The cooking device of claim 9, wherein the offset combustion chamber provides an adjustable air intake between a level of the smoking rack and a level of the fuel rack.

11. The cooking device of claim 9, wherein the pressure conduit communicates with the offset combustion chamber below the level of the smoking rack and the smoke valve is situated above the level of the smoking rack.

12. A cooking device comprising:
a cooking chamber supporting a cooking grate;
a solid fuel firepot below the cooking grate;
a fuel feed mechanism supplying fuel to the firepot;
an air plenum delivering pressurized air to the firepot;
an offset combustion chamber selectively communicable with the cooking chamber to supply smoke;
a pressure conduit adjustably supplying pressurized air into the combustion chamber.

13. The cooking device of claim 12, further comprising a pressure valve having a plurality of selectable positions including open, closed, and at least one partially open position.

14. The cooking device of claim 13, further comprising a smoke valve having at least an open and closed position for placing the offset combustion chamber in communication with the cooking chamber.

15. The cooking device of claim 14, wherein the offset combustion chamber includes a manifold routing pressurized air from the pressure conduit to a plurality of air ducts distributing the pressurized air within the offset combustion chamber.

16. The cooking device of claim 15, further comprising an adjustable air inlet to the offset combustion chamber.

17. The cooking chamber of claim 16, further comprising a heat spreader interposing the fire pot and the cooking chamber, the heat spreader providing a sear control plate that is adjustable to alter gas flow through the heat spreader to concentrate or spread combustion gases relative to a location on the cooking grate.

18. A method of cooking comprising:
providing:
a cooking chamber containing a fire pot that receives pellet fuel for combustion under positive pressure from an air supply;
an offset combustion chamber adjacent to the cooking chamber;
a smoke valve that is selectively openable to allow gas flow from the offset combustion chamber to the cooking chamber; and
a pressure conduit containing a pressure valve that, when open, provides positive pressure from the air supply to the offset combustion chamber and, when closed, inhibits positive pressure from the air supply to the offset combustion chamber.

19. The method of claim 18, further comprising:
creating a solid fuel heat source in the fire pot;
initiating a smoke generating heat source in the offset combustion chamber;
opening the smoke valve; and
opening the pressure conduit.

20. The method of claim 18, further comprising:
creating a smoke generating heat source in the offset combustion chamber;
closing the pressure conduit; and
opening the smoke valve.
